(19) United States
(12) Patent Application Publication
(10) Pub. No.: US 2006/0060513 A1
(43) Pub. Date: Mar. 23, 2006

(54) Surface pool skimmer

(76) Inventor: Roger Scott Craig, Springville, CA (US)

Correspondence Address: JANSSON, SHUPE, MUNGER & ANTARAMIAN, LTD, 245 MAIN STREET, RACINE, WI, 53403, US

(21) Appl. No.: 11/105,030

(22) Filed: Apr. 13, 2005

Related U.S. Application Data
(60) Provisional application No. 60/612,114, filed on Sep. 23, 2004.
(60) Provisional application No. 60/644,791, filed on Jan. 18, 2005.

(51) Int. Cl. B01D 35/02; B01D 35/05

(52) U.S. Cl. 210/169; 210/739

(57) ABSTRACT

A surface pool skimmer includes a body, a propulsion member attached to the body for propelling the body along a water surface, a skimmer attached to the body for collecting debris from the water surface, a remote control transmitter structured to transmit control signals, and a remote control receiver attached to the body and structured to receive the control signals for controlling operation of the propulsion member. A method of cleaning a pool of water includes providing an untethered surface pool skimmer having a propulsion member for propelling the surface pool skimmer along the surface of the water, and controlling the propulsion member via remote control.

### REFERENCE TO RELATED APPLICATIONS

This application claims the benefits of Provisional Application Ser. No. 60/612,114, filed Sep. 23, 2004, and Provisional Application Ser. No. 60/644,791, filed Jan. 18, 2005, both incorporated herein by reference.

### FIELD OF THE INVENTION

The invention relates generally to maintaining a swimming pool and, more particularly, to a system and method for enhanced control of swimming pool cleaning.

### BACKGROUND OF THE INVENTION

Swimming pools are an important part of a leisurely home or resort environment, providing an aesthetically pleasing and healthy way to keep cool on a hot day, and providing a social center where people can gather to be festive or enjoy just “hanging out.” Water has a generally calming and somewhat spiritual effect that adds to the poolside atmosphere. Traditional maintenance of swimming pools has included cleaning of the water's surface, vacuuming the bottom of the pool, and various other pool tasks such as cleaning of filters, water testing and analysis, and addition of chemicals.

A common method of cleaning a pool's surface water of leaves and other floating debris has included use of a net attached to the end of a long pole. However, most poolside people have better things to do with their time than fish out leaves one by one with a long extension pole, even if such things only include more hanging out. In addition, the use of a long pole is awkward and can cause a person to strain his/her back or even fall accidentally into the pool. Cleaning the surface of a swimming pool has therefore been a time-consuming, back-breaking chore.

It is known to use automated pool surface skimmers instead of using a long extension pole with a net attached to the end to manually remove debris before taking a swim. However, such automated pool surface skimmers are not optimized for efficiency or controllability. For example, often there exists a limited amount of surface debris in a few distinct locations in a swimming pool. What is needed is a surface pool skimming apparatus and method for going directly to the location of the debris.

### OBJECTS OF THE INVENTION

It is an object of the invention to provide an improved surface pool skimmer overcoming some of the problems and shortcomings of the prior art, including those referred to above.

Another object of the invention is to provide a surface pool skimmer that implements new methods for cleaning and maintaining a swimming pool.

Another object of the invention is to provide a surface pool skimmer with an operation that is remotely controllable.

Another object of the invention is to provide a surface pool skimmer adapted for utilizing solar power for providing at least a part of the electrical energy consumption requirements of the pool skimmer.

Another object of the invention is to provide a surface pool skimmer adaptable to using any of several different types of propulsion devices for moving the pool skimmer along the surface of the water.

How these and other objects are accomplished will become apparent from the following descriptions and the drawings.

### SUMMARY OF THE INVENTION

According to an aspect of the invention, apparatus includes a body, a propulsion member attached to the body for propelling the body along a water surface, a skimmer attached to the body for collecting debris from the water surface, a remote control transmitter structured to transmit control signals, and a remote control receiver attached to the body and structured to receive the control signals for controlling operation of the propulsion member.

In various configurations, a surface pool skimmer may be provided without a solar panel for recharging, and including only some of the various structures described herein.

As a result of implementing the present invention, pool operators can utilize a whole new generation of surface pool skimmers that clean and maintain a swimming pool with very little effort, making what was formerly a dreary and monotonous job an activity the whole family is sure to enjoy.

The foregoing summary does not limit the invention, which is instead defined by the attached claims.

### BRIEF DESCRIPTION OF THE DRAWING FIGURES

FIG. 1 is a front view of a surface pool skimmer according to an exemplary embodiment of the invention.

FIG. 2 is a perspective view of an interior portion of a surface pool skimmer according to an exemplary embodiment of the invention.

FIG. 3A is a top view of an impeller structure used for propulsion of a surface pool skimmer according to an exemplary embodiment of the invention; FIG. 3B is a side view of the impeller structure of FIG. 3A connected to a motor and motor body assembly according to an exemplary embodiment of the invention.

FIG. 4 is a schematic block diagram of control circuitry for a surface pool skimmer according to an exemplary embodiment of the invention.

FIG. 5 is a perspective view of an interior portion of a surface pool skimmer according to an exemplary embodiment of the invention.

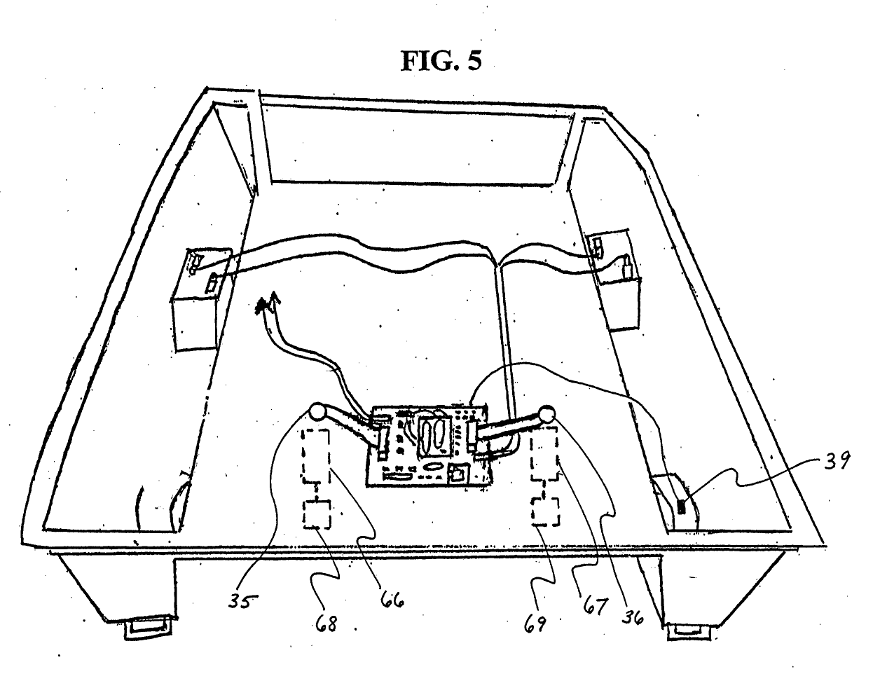

FIG. 6 is a schematic diagram of a remote control transmitter according to an exemplary embodiment of the invention.

FIG. 7 is a schematic diagram of a remote control receiver according to an exemplary embodiment of the invention.

### DETAILED DESCRIPTION OF PREFERRED EMBODIMENTS

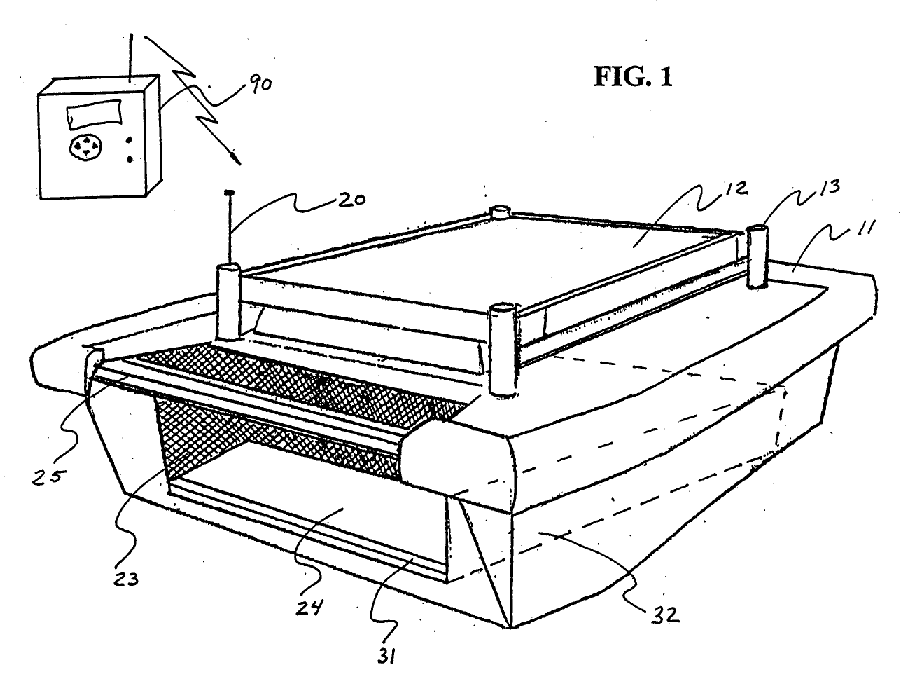

FIG. 1 shows a perspective view of a remote control type surface pool skimmer 10 and remote control transmitter 90 according to an exemplary embodiment. A debris basket 32 in the center of skimmer 10 is easily removed, then emptied by inverting the tray-like basket 32. Basket 32 then slides back quickly and easily into place using side rails (not shown) for guiding basket 32. A handle 25 is provided for pulling or pushing basket 32 for removal or insertion, respectively. Each basket 32 has a flap 24 that closes automatically when skimmer 10 reverses direction, thereby preventing any debris from escaping back into the swimming pool. Flap 24 opens and closes with the directional flow of the water through the skimmer's basket 32 by the action of hinge 31. A screen 23 is used in forming most of basket 32 so that water passes through while debris is trapped inside.

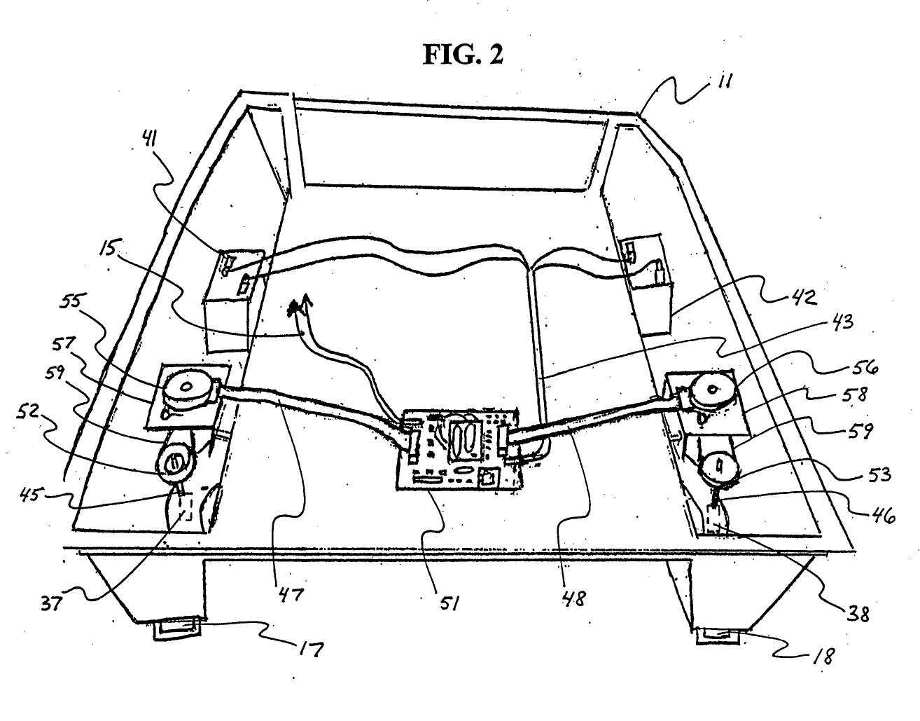

FIG. 2 shows the upper interior portion of surface pool skimmer 10 containing batteries 41, 42, circuit board 51, motors 55, 56, gear reducing mechanisms 57, 58, belts 59, gears 52, 53, and shafts 45, 46. Motors 55, 56 may be a DC brushless type such as a Model DR4312-007D available from Shinao Kenshi Corporation. Such motors have a low profile, a relatively high efficiency, excellent speed-torque characteristics, and are highly controllable for reversing direction of rotation. Motors 55, 56 are respectively electrically connected to circuit board 51 via cables 47, 48. Gear reducing mechanisms 57, 58 may be used for reducing the motor speed to a smaller speed for driving the impellers or propellers. For example, a 10:1 gearing may be used. The mechanical output from gear reducers 57, 58 is respectively transferred to shafts 45, 46 via belts 59 and sprockets/gears 52, 53. Shafts 45, 46 are then respectively connected to impeller assemblies 37, 38. When pumps are being used for propulsion, they may be a model 10000-1.3 available from Ireland Engineering of Los Angeles, Calif.

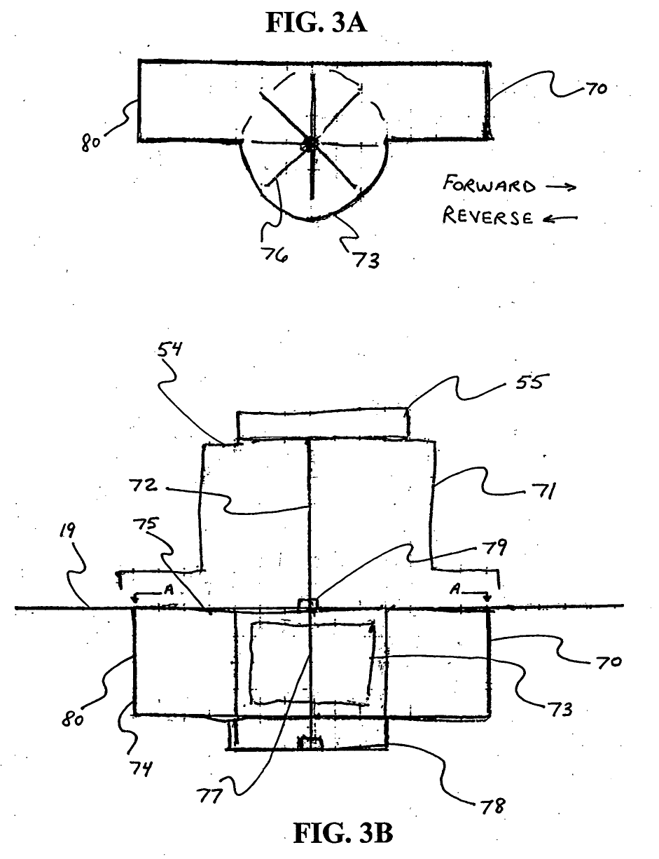

FIGS. 3A and 3B respectively show a top view and a side view of an exemplary impeller assembly. In this example, a separate belt and auxiliary gear are not being used for transferring the motor output. Motor 55 is mounted on a top surface 54 of motor base 71, which may include a motor shaft extension 72 that either directly transmits a shaft rotation produced by motor 55 or that includes a gear reduction assembly (not shown) for reducing a speed of shaft rotation being transferred to impeller 73. An impeller housing 74 has a top surface 75 that is sealingly affixed to an impeller mounting surface 19 of body 11. Impeller housing 74 contains impeller 73 that may be formed as a spoke type paddle member 76 having its own impeller shaft 77. Impeller housing 74 may have a housing cap 78 with a bearing assembly for maintaining proper shaft rotation. At a top side of impeller housing 74, a mechanical interface 79 connects shaft 72 and shaft 77 via a bearing assembly, thereby keeping the water in impeller 73 from leaking into motor base 71. Impeller housing 74 has an inlet/outlet water channel 70 and a corresponding water flow channel 80 at the opposite end of impeller housing 74. Although the illustrated embodiments are shown as having impellers, the invention is not limited to any particular propulsion system. For example, a propeller can alternatively be used, in which case a protective cage or mesh is used to cover the propeller blades to keep debris from being wrapped around the propeller blades and affecting motor action.

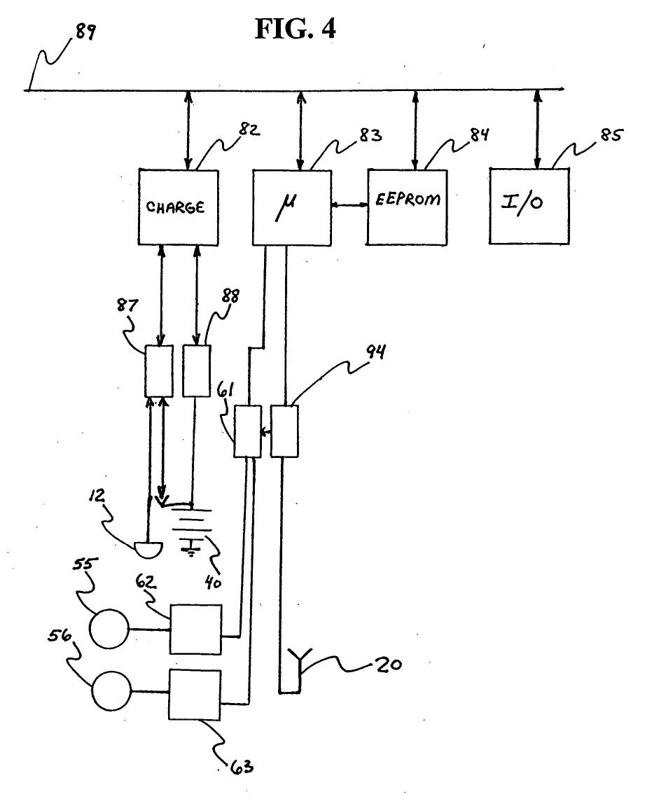

Solar panel 12 may be a type KY 5 watt panel having a Voc of 22 Volts, a Vop of 13.5 volts, and an Isc of 450 mA. For example, a model number SKU4114 available from Harbor Freight is suitable. Solar panel 12 is mounted on top of body 11 and is used as a photovoltaic electrical recharging source that, when receiving at least a threshold amount of sunlight, generates a current fed to power interface circuit 87 as illustrated in FIG. 4. The voltage of multi-cell battery pack 40 is monitored by battery voltage monitoring circuit 88, and the operations of circuits 87, 88 are controlled by charging control circuit 82, which regulates a charging current so that when battery pack 40 is fully charged, only a trickle charge type current is supplied to battery pack 40 and so that when the voltage of battery pack 40 is low, a full charging current is supplied. Battery pack 40 is comprised of individual six volt batteries 41, 42 connected in series and may be separately recharged via an external connector (not shown) when it is desired to charge battery pack 40 without using solar panel 12. Such an external connector may be a plug-in type connection having mechanical contacts, physically engaged with each other, or may be a non-intrusive induction type connection, whereby a risk of damage due to breach of a watertight electrical connection is avoided. For example, an induction type connection may include a docking station (not shown) having non-contact power feeding through electromagnetic induction. In such a case, each of the power interface 87 and the given charger contains an induction coil. When a current is flown through the coil in the charger with the respective coils set to be close to each other, a charging current is generated in the coil in power interface 87 through electromagnetic induction.

When assembling pool skimmer 10, batteries 41, 42 are first connected to circuit board 51, and then solar panel 12 is connected via wires 15. Batteries 41, 42 may be a 6 volt, 4.5 Amp-hour rechargeable type, such as a sealed lead-acid battery having a part number TY-6-4.5 and available from Tysonic, or a Tempest No. TR5.6A. A power switch (not shown) may be used for turning power to the circuit board on or off.

Charging control circuit 82 is connected to a buss 89 along with DSP 81, microcontroller 83, EEPROM 84, and input/output (I/O) device 85. The I/O device 85 provides external connections for remote programming of EEPROM 84 and any other programmable circuits. Motors 55, 56 are provided with respective motor drive circuits 62, 63, which include both Hall type circuits and power transistor drive circuits, along with over-current protection. The motors 55, 56 are provided with Hall type connections, which allows for increased efficiency and control. Since motor drive circuits 62, 63 are analog, a motor control circuit 61 includes a digital-to-analog converter so that digital control signals from microcontroller 83 can be converted to analog control signals. Motor control circuit 61 also is structured for activating only one motor at a time, or it can maintain a desired balance between motor drive currents, such as when both motors 55, 56 are running and it is desired to control the propulsion ratio between the motors, for example when a “soft turn” or when an “all ahead full” type propulsion is desired.

A remote control receiver 94 is connected to an antenna 20 mounted on top of body 11, receives commands from RC transmitter 90, and feeds those commands to microcontroller 83 and/or directly to motor control circuit 61. The commands may include any combination of On/Off, Left, Right, Forward, Reverse, Speed-Up, Slow-Down, and others.

In one exemplary variation, when the circuit board is first turned on, it may enter a four minute off cycle to allow an external computer (not shown) to communicate with circuit board 51 via a COM port (not shown) such as by using a control program application of Visual BASIC or the like. After such four minute wait period, the main solar charging cycle will start if the sun is above the detected threshold, such as by being a minimum of fifteen degrees above the horizon and/or by being set to a thirty-three degree default. The solar charging circuit will go back to a sleep mode if there is not enough sunlight.

The circuit board (and the entire unit 1) can be put to sleep (turned off) by setting a speed control (not shown) to the full counter-clockwise position. If the batteries 41, 42 have been left connected, a trickle charge is maintained even with indoor lighting. When sufficient charging light has not been detected within 20 minutes, such as when the unit is being stored in the dark or at nighttime, the batteries are disconnected by an internal watchdog circuit. To turn the unit 10 back on, the speed control may be fully turned in the clockwise direction and then back to the proper speed setting. If the unit 10 is in the sleep mode, attempted computer communication will result in a “no response” message. The speed control can then be turned fully counter-clockwise for three seconds and then be returned fully clockwise, which will terminate the sleep mode, start the four minute off cycle, and then allow communication between the circuit board and the external computer. The speed control can then be returned to the proper setting.

If the sun amount is greater than the minimum threshold setting after the four minute period, the cycle will start. The unit can be programmed to start either with an on cycle or with an off cycle. In a default mode, the off cycle allows the batteries 41, 42 to charge for approximately three hours before starting the motor forward and reverse cycles for a default period of one hour. The unit can also be programmed to terminate the off cycle if the battery re-charges before the three-hour period is complete.

The number of on/off cycles can be set to a default of a total of eight cycles, four on cycles and four off cycles. For example, the eight cycles may be set to alternately be an off cycle followed by an on cycle followed by an off cycle, etc. Such allows for a change of direction on every other cycle, such as by turning left on a first reverse cycle, turning right on a next forward cycle, turning right on a next reverse cycle, turning left on a next forward cycle, etc. The motors 55, 56 can alternatively be trimmed to allow the unit to run in a straight line in either the forward or reverse direction. The control firmware is set to turn the motor(s) completely off when switching between a forward and a reverse direction, and vice versa. A time delay is implemented so that the motor(s) coast to a stop before starting again. A pulse width modulation (PWM) is used for driving the motor(s) when battery voltage is greater than or equal to ten volts.

The unit monitors the battery voltage and turns the solar panel on and off as the battery requires. The solar panel will charge the batteries to 14.7 volts, then switch the charging circuit to maintain a trickle charge between 13.4 and 13.7 volts in order to avoid overcharging the battery. The charge thresholds are temperature compensated according to the battery manufacturer recommendations.

The motor(s) are designed to be burnout proof. The motor drive transistors are either on or off and the current is limited to around 800 mA according to the motor manufacturer's safety specifications. If the software detects a locked rotor, the drive current is reduced to one-quarter of the nominal current. Additionally or alternatively, a thermistor circuit may be used for motor protection.

A remote control (RC) transmitter 90 may be a Futaba RC Controller having a part number T2PHKA, and having a carrier frequency of 75.410 MHz. An RC receiver may be obtained from Futaba and may or may not be incorporated with a servo motor. However, such a servo motor only adds to the cost and is not typically required unless additional structure such as one or more rudders are used for increasing steering accuracy. In a preferred embodiment, an RC receiver is simply incorporated into circuit board 51 and has a tuned receiving section such as a heterodyne type RLC circuit, a local oscillator (LO) for mixing down the frequency of a received signal, analog filtering such as a bandpass filter, and an analog-to-digital (A/D) circuit for allowing the RC receiver to produce a digital output signal. An exemplary method of remote control operation is described herein below.

The remote control skimmer 10 provides directional flexibility by enabling steering to the left or right as a result of respectively powering only the right or left motor 56, 55. The respective impellers 37, 38 may also have their direction reversed to effect propulsion forwards or backwards. The control of each of these functions is provided by a triggering mechanism on the hand-held RC controller 90.

The user can watch pool side as RC skimmer 10, powered by solar-rechargeable batteries 41, 42, effortlessly cleans the surface of her swimming pool by swallowing up leaves, insects and other debris. Skimmer 10 can easily be transformed between given ornamental designs simply by exchanging the attachable covers (not shown). For example, a skimmer 10 may have a cover that provides the appearance of a sailboat and a second cover that provides the appearance of a speedboat, etc. Skimmer 10 can thereby function as an ersatz toy while also cleaning the pool.

Electrical connection to motors 66, 67 is provided by using watertight connectors 35, 36. A watertight seal 39, such as silicone or the like, is used for sealing wires to circuit board 51.

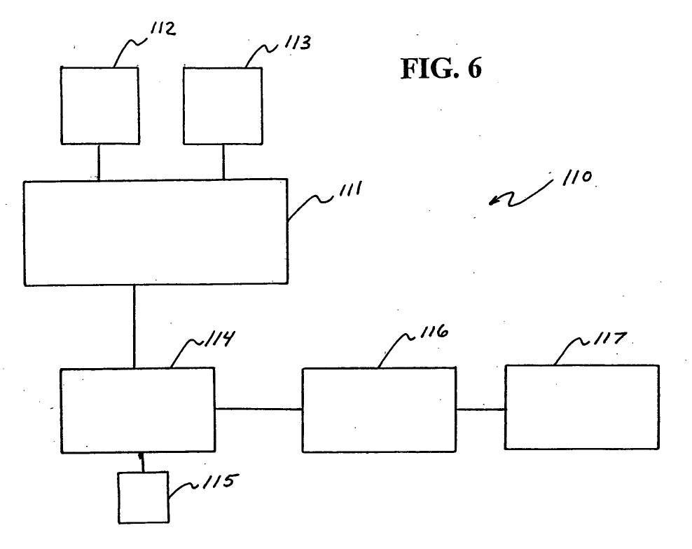

Another exemplary remote control transmitter 110 is schematically shown in FIG. 6. Encoding of a data transmission and control of operation of the various components of the transmitter 110 are performed by a microprocessor 111. A number of switch(es) 112 (e.g., on/off, forward/reverse) and/or joystick(s) 113 are respectively moved to control positions that provide control inputs to microprocessor 111. Microprocessor 111 receives these control inputs and encodes the signals by generating corresponding data bits that are assembled into data packets along with control bits, flags, checksums, and the like. The data packets are then transmitted by microprocessor 111 as control packets to an RF amplifier 114, the data packets being continuously assembled and transmitted over and over as a continuous stream of packets, or as a periodically assembled and transmitted set of packets. As a result, any position change of switch(es) 112 and joystick(s) 113 results in a change of the transmitted data. Various schemes may be employed for organizing and transmitting the data corresponding to position information of switch(es) 112 and joystick(s) 113.

RF amplifier 114 has an RF oscillator 115 preferably including a crystal, such as a crystal that oscillates at a fixed frequency between 47 and 54 MHz. One of ordinary skill in the art would recognize that any suitable RF oscillation frequency may be used, including a frequency created by use of frequency multipliers and the like. RF amplifier 114 modulates and amplifies the RF signal using the data packets received from microprocessor 111. The amplified and modulated RF signal is fed to an antenna matching circuit 116 and is thereby fed to an antenna 117 that radiates the signal.

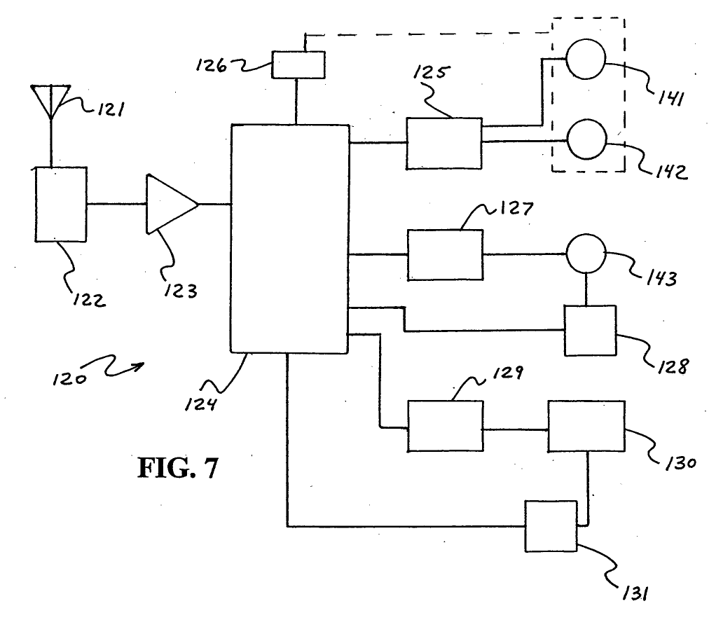

FIG. 7 is a schematic of an exemplary receiver circuit 120 in an embodiment of pool skimmer 10. Receiver circuit 120 receives and demodulates signals from transmitter 90, receiver circuit 120 being a part of circuit board 51 or provided on a separate circuit board. An antenna 121 is adapted for the particular frequency being used and feeds the received signals to a receiver/demodulator circuit 122, which is preferably a super-regenerative type receiver tuned to operate at the same frequency as the transmitter, thereby demodulating the received signals, such as by heterodyne operation. Receiver/demodulator 122 preferably includes an LCR tank circuit and a precision voltage regulation circuit for accurately tuning to the desired frequency. The demodulation includes a signal amplifier section 123, for example a high-gain differential amplifier that operates to provide a well-defined information signal to a microprocessor 124. Microprocessor 124 may have an external or internal clock, depending on the chosen application. For example, a resistor programmed oscillator clock may suffice for simple pool skimming applications, a crystal based clock may be used for high accuracy applications, some microprocessors may already contain on-board clock circuits, etc. Microprocessor 124 receives the demodulated and amplified signals from amplifier 123 and is programmed to read and decode the signals and to control the operations of surface pool skimmer 10 based on the decoded control signals. An exemplary microprocessor suitable for receiving circuit 120 is a PIC 16C55 series microcontroller available from Microchip Technology, Inc.

Output control signals from microprocessor 124 are provided to a high-power drive motor H-bridge 125 for controlling operation of two separate drive motors 141, 142. Thermistors 126 and associated circuitry are provided for each motor 141, 142 for sensing the temperature of the drive motors 141, 142, providing feedback to microprocessor 124 in order to prevent overheating of a motor by turning the given motor off when a predetermined temperature is reached. In a preferred embodiment, high-power drive motor H-bridge 125 is adapted for supplying proportional amounts of power to motors 141, 142 for effecting left or right steering without the use of additional components. For example, H-bridge 125 may be controlled to supply sixty percent of motor power to motor 141 and forty percent to motor 142, thereby causing pool skimmer 10 to veer in a direction dictated by motor 141. The total amount of motor power will determine the speed. In addition, H-bridge 125 is preferably adapted for reversing a polarity of the respective electrical signals being supplied to motors 141, 142, thereby effecting a forward or reverse direction of travel for pool skimmer 10. Depending on a particular application, suitable H-bridges may be, for example, an IR3220S, available from International Rectifier, or a ZHB6718, available from Zetex.

In an alternative embodiment, pool skimmer 10 has a steering motor 143 and receive circuit 120 is adapted for controlling same. In such a case, microprocessor 124 produces output control signals that are provided to a medium-power steering motor H-bridge 127 to control the operation of steering motor 143. The steering motor assembly preferably includes a steering position feedback circuit 128 that provides feedback signals to microprocessor 124 for monitoring of the radial position of a shaft connected to motor 143, or for monitoring the location of an arm or other mechanism being moved by motor 143. For example, a steering mechanism may be a rudder (not shown) that is adapted to move about a center axis, so that the rudder may be pushed or pulled to rotate about the center axis for steering pool skimmer 10 as it is being propelled along the surface of a body of water.

Other output control signals from microprocessor 124 may be provided to an auxiliary control circuit 129 that operates to implement auxiliary circuit(s), for example switching on/off of indicator LEDs, tooting a foghorn, performing a test such as a battery evaluation or other test, switching on/off an onboard camera, switching on/off running lights, and performing other controllable operations. As shown by way of example, auxiliary equipment 130 is controlled by auxiliary controller 129, and a feedback circuit 131 is provided for monitoring performance of auxiliary equipment 130.

In another exemplary embodiment, when a user needs to have both hands free for more important work, the pool skimmer 10 may be configured for cleaning the swimming pool, without a use of human interface for a remote control. Such a unit is programmed to turn itself on and off throughout each day and incorporates bump sensors that cause the motors to automatically reverse when the unit comes in contact with the side of the pool. When in reverse the motors run at different RPMs causing the skimmer to back up at an angle and turn itself around before moving forward again. In such a case, for example, a remote control may be operated using pre-programmed instructions, where a user selects a routine from a menu and instructs the pool skimmer to start the routine via the remote control device.

Although the embodiments described above each utilize a radio frequency (RF) type remote control system for sending commands to a surface pool skimmer, the method of remote controlling may instead utilize other types of communication, for example an infrared type remote control system. Any of the above-identified components may be effected using components well known in the remote control vehicle arts.

While the principles of the invention have been shown and described in connection with specific embodiments, it is to be understood that such embodiments are by way of example and are not limiting. Consequently, variations and modifications commensurate with the above teachings, and with the skill and knowledge of the relevant art, are within the scope of the present invention. The embodiments described herein are intended to illustrate best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

What is claimed is:

1. Apparatus comprising:
a body;
a propulsion member attached to the body for propelling the body along a water surface;
a skimmer attached to the body for collecting debris from the water surface;
a remote control transmitter structured to transmit control signals; and
a remote control receiver attached to the body and structured to receive the control signals for controlling operation of the propulsion member.

2. Apparatus of claim 1 further comprising at least one battery providing electrical power to the propulsion member and the remote control receiver.

3. Apparatus of claim 2 wherein the at least one battery is rechargeable.

4. Apparatus of claim 3 further comprising a solar panel adapted for delivering electrical power to the at least one battery.

5. Apparatus of claim 1 wherein the propulsion member comprises at least one electric motor.

6. Apparatus of claim 5 further comprising an impeller adapted for being driven by the electric motor.

7. Apparatus of claim 1 wherein the operation controlled by control signals includes at least one of left/right steering and forward/reverse movement of the body through the water.

8. A method of cleaning a pool of water, comprising:
providing an untethered surface pool skimmer having a propulsion member for propelling the surface pool skimmer along the surface of the water; and
controlling the propulsion member via remote control.

9. The method of claim 8 wherein the controlling includes selectively causing the propelling to turn the surface pool skimmer in a right or left direction.

10. The method of claim 8 wherein the controlling includes selectively causing the propelling to move the surface pool skimmer in a forward or reverse direction.

11. The method of claim 8 further comprising steering the surface pool skimmer to debris via the remote control.

12. An untethered surface pool skimmer comprising:
means for propelling the untethered surface pool skimmer along the surface of a pool of water;
means for controlling the propelling via remote control; and
means for steering the untethered surface pool skimmer to debris via the remote control.

13. An untethered surface pool skimmer comprising:
a floating skimmer having a removable debris basket with a screen for trapping debris and a handle for pulling or pushing the basket for removal or insertion, respectively;
at least one first electric motor with a propeller for propelling the skimmer along the surface of a body of water;
a rudder having a rudder mount with a central axis;
a second electric motor for moving the rudder about the central axis, thereby steering the skimmer being propelled along the surface of the water;
a remote control transmitter having a plurality of controls for directing the propelling and steering of the skimmer, having an encoder for obtaining encoded control signals based on at least one position of the controls, and having a transmission section for generating transmission signals based on the encoded control signals;
a receiver disposed in the skimmer and having a receive section for receiving the transmission signals from the remote control transmitter, having a demodulator for decoding the received transmission signals, and having a controller for generating motor activation signals based on the received transmission signals;
at least one battery for supplying electric power to the skimmer; and
at least two switches operative to selectively supply power to the first and second motors based on the motor activation signals.
